(19) United States
(12) Patent Application Publication
(10) Pub. No.: US 2024/0413305 A1
(43) Pub. Date: Dec. 12, 2024

(54) POSITIVE ELECTRODE PLATE AND NON-AQUEOUS ELECTROLYTE SECONDARY BATTERY

(71) Applicant: Prime Planet Energy & Solutions, Inc., Tokyo (JP)

(72) Inventors: Takatoshi HIGUCHI, Kakogawa-shi (JP); Kazunori DONOUE, Kobe-shi (JP)

(21) Appl. No.: 18/675,160

(22) Filed: May 28, 2024

(30) Foreign Application Priority Data
Jun. 9, 2023 (JP) 2023-095674

(51) Int. Cl. H01M 4/36; H01M 4/02; H01M 4/525

(52) U.S. Cl. CPC H01M 4/364; H01M 4/525; H01M 2004/028

(57) ABSTRACT

A positive electrode plate includes a first active material that is a lithium-(transition metal) composite oxide, and a second active material that is a lithium-(transition metal) composite oxide having a smaller average particle size (D50) than the first active material. A crystallite size of the second active material is 800 nm or more. A ratio (Li/M) between a number of moles of lithium (Li) and a total number of moles of transition metal (M) in the first active material is 1.05 or more. A ratio (Li/M) between a number of moles of lithium (Li) and a total number of moles of transition metal (M) in the second active material is 1.04 or less.

### CROSS REFERENCE TO RELATED APPLICATIONS

This nonprovisional application is based on Japanese Patent Application No. 2023-095674 filed on Jun. 9, 2023, with the Japan Patent Office, the entire contents of which are hereby incorporated by reference.

### BACKGROUND OF THE INVENTION

### Field of the Invention

The present invention relates to a positive electrode plate and a non-aqueous electrolyte secondary battery.

### Description of the Background Art

It is known to use a lithium-(transition metal) composite oxide, which is a composite oxide of lithium and transition metal, as a positive electrode active material in an active material layer of a positive electrode plate in a non-aqueous electrolyte secondary battery such as a lithium-ion secondary battery. Japanese National Patent Publication No. 2021-518049, Japanese Patent Laying-Open No. 2011-113825, and International Patent Laying-Open No. WO 2021/065162 disclose that it is possible to enhance capacity, power output, and the like by using a positive electrode plate that includes two or more lithium-(transition metal) composite oxides that are different in particle size and the like.

### SUMMARY OF THE INVENTION

In a non-aqueous electrolyte secondary battery, thermal stability can be degraded when the charged capacity is increased. Under such circumstances, a demand exists for development of a non-aqueous electrolyte secondary battery that has enhanced charged capacity and excellent thermal stability.

An object of the present disclosure is to provide a positive electrode plate that has enhanced charged capacity and excellent thermal stability, as well as a non-aqueous electrolyte secondary battery including the same.
[1] A positive electrode plate comprising:
a first active material that is a lithium-(transition metal) composite oxide; and
a second active material that is a lithium-(transition metal) composite oxide having a smaller average particle size (D50) than the first active material, wherein
a crystallite size of the second active material is 800 nm or more,
a ratio (Li/M) between a number of moles of lithium (Li) and a total number of moles of transition metal (M) in the first active material is 1.05 or more, and
a ratio (Li/M) between a number of moles of lithium (Li) and a total number of moles of transition metal (M) in the second active material is 1.04 or less.
[2] The positive electrode plate according to [1], wherein the ratio (Li/M) between a number of moles of lithium (Li) and a total number of moles of transition metal (M) in the first active material is 1.12 or less.
[3] The positive electrode plate according to [1] or [2], wherein the ratio (Li/M) between a number of moles of lithium (Li) and a total number of moles of transition metal (M) in the second active material is 0.98 or more.
[4] The positive electrode plate according to any one of [1] to [3], wherein the ratio (Li/M) between a number of moles of lithium (Li) and a total number of moles of transition metal (M) in the second active material is 1.01 or more.
[5] The positive electrode plate according to any one of [1] to [4], wherein a mass ratio between the first active material and the second active material ((first active material)/(second active material)) is from 5/5 to 8/2.
[6] The positive electrode plate according to any one of [1] to [5], wherein an average particle size (D50) of the first active material is from 12 μm to 20 μm.
[7] The positive electrode plate according to any one [1] to [6], wherein an average particle size (D50) of the second active material is from 2 μm to 8 μm.
[8] The positive electrode plate according to any one of [1] to [7], wherein each of the first active material and the second active material includes nickel (Ni) in an amount of 80 mol % or more of a total amount of transition metal.
[9] The positive electrode plate according to any one of [1] to [8], wherein the second active material is at least one of a single particle and a secondary particle formed of up to three primary particles aggregated together.
[10] A non-aqueous electrolyte secondary battery comprising:
an electrode assembly having the positive electrode plate according to any one of [1] to [9], a negative electrode plate, and a separator interposed between the positive electrode plate and the negative electrode plate; and an electrolyte solution.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a graph of charged capacity and a ratio of capacity at an electric potential of 4.1 V vs. Li/Li⁺ or more at the time of charging a test cell (r1) having a positive electrode plate (r1) formed by using a first active material, plotted with respect to the ratio (Li/M) between the number of moles of lithium (Li) and the total number of moles of transition metal (M) in the first active material.

FIG. 2 is a graph of charged capacity and a ratio of capacity at an electric potential of 4.1 V vs. Li/Li⁺ or more at the time of charging a test cell (r2) having a positive electrode plate (r2) formed by using a second active material, plotted with respect to the ratio (Li/M) between the number of moles of lithium (Li) and the total number of moles of transition metal (M) in the second active material.

### DESCRIPTION OF THE PREFERRED EMBODIMENTS

### (Positive Electrode Plate)

A positive electrode plate according to the present embodiment can be used in a non-aqueous electrolyte secondary battery (hereinafter also called “a secondary battery”). The positive electrode plate includes a first active material that is a lithium-(transition metal) composite oxide, and a second active material that is a lithium-(transition metal) composite oxide having a smaller average particle size (D50) than the first active material. The crystallite size of the second active material is 800 nm or more.

The lithium-(transition metal) composite oxide is an oxide that includes lithium and a transition metal. Examples of the transition metal included in the lithium-(transition metal) composite oxide include one or more types selected from the group consisting of nickel (Ni), manganese (Mn), cobalt (Co), aluminum (Al), and titanium (Ti), preferably one or more types selected from the group consisting of Ni, Mn, Co, and Al, more preferably one or more types selected from the group consisting of Ni, Mn, and Co. Preferably, the transition metal includes Ni, Mn, and Co, and it may include Ni, Mn, Co, and Al.

Preferably, each of the first active material and the second active material independently includes Ni in an amount of 80 mol % or more of the total amount of the transition metal, more preferably from 80 mol % to 98 mol %, optionally from 81 mol % to 95 mol %, optionally from 82 mol % to 90 mol %. By using a first active material and a second active material in which the Ni content falls within the above-mentioned range, it is possible to enhance the capacity of the secondary battery.

The ratio (Li/M) between the number of moles of Li and the total number of moles of transition metal (M) in the first active material is 1.05 or more, or may be 1.07 or more, or may be 1.09 or more. The ratio (Li/M) in the first active material is preferably from 1.05 to 1.12, or may be from 1.05 to 1.10, or may be from 1.07 to 1.10, or may be from 1.07 to 1.09.

The ratio (Li/M) between the number of moles of Li and the total number of moles of transition metal (M) in the second active material is 1.04 or less, or may be 1.03 or less, or may be 1.02 or less. The ratio (Li/M) in the second active material is preferably from 0.98 to 1.04, or may be from 1.00 to 1.04, more preferably from 1.01 to 1.04, or may be from 1.02 to 1.03. The composition of the first active material and the second active material (lithium-(transition metal) composite oxides) can be determined by high-frequency inductively coupled plasma (ICP) emission spectrometry.

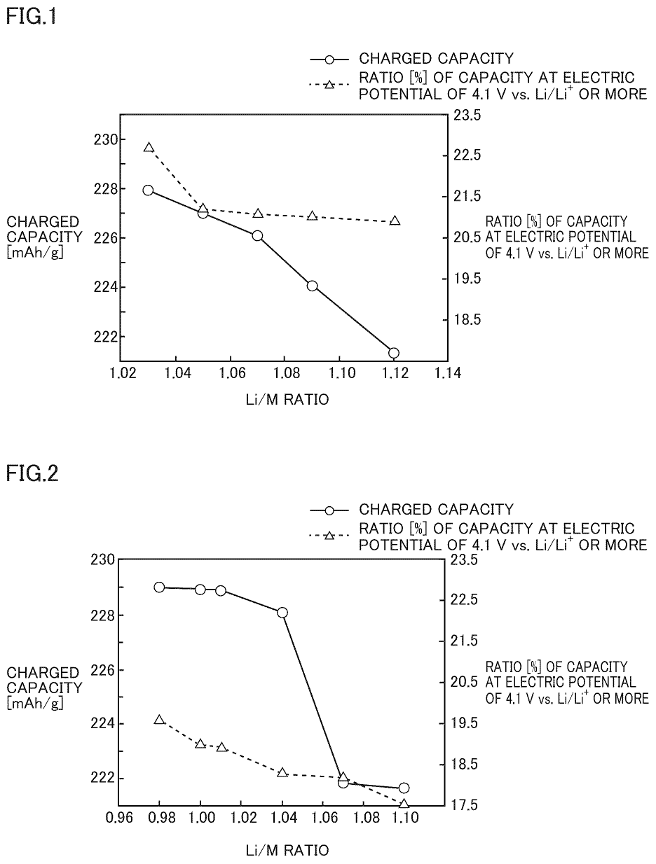

As will be described in Production Examples of the Examples section, when the ratio (Li/M) in the first active material is less than 1.05, at the time of charging a test cell (r1) having a positive electrode plate (r1) formed by using the first active material, the ratio of capacity at an electric potential of 4.1 V vs. Li/Li⁺ or more is great relative to the total capacity (FIG. 1 and Table 1). On the other hand, when the ratio (Li/M) in the first active material is 1.05 or more, the ratio of capacity tends to be stable without a great change (FIG. 1 and Table 1). It is conceivable that along with an increase of the ratio of capacity at an electric potential of 4.1 V vs. Li/Li⁺ or more at the time of charging the test cell (r1), the structural stability of the lithium-(transition metal) composite oxide of the first active material is degraded, facilitating phase transition of the lithium-(transition metal) composite oxide. As a result, the electric potential during charging of the secondary battery tends to rise, causing an increase of the ratio of capacity at the electric potential. The ratio of capacity is an index of the thermal stability of the test cell (r1), and the lower the ratio of capacity is, the more excellent the thermal stability is. Hence, whether or not the ratio (Li/M) in the first active material is 1.05 or more is considered to have a great influence on the thermal stability of the secondary battery.

In this regard, when the ratio (Li/M) in the second active material is 1.04 or less, at the time of charging a test cell (r2) having a positive electrode plate (r2) formed by using the second active material, the charged capacity per unit mass of the second active material can be high (Production Examples of the Examples section below, FIG. 2, and Table 2). On the other hand, when the ratio (Li/M) in the second active material is more than 1.04, the charged capacity tends to be degraded by a great margin (FIG. 2 and Table 2). Hence, whether or not the ratio (Li/M) in the second active material is 1.04 or less is considered to have a great influence on the amount of the charged capacity of the secondary battery.

Hence, when a first active material having a ratio (Li/M) of 1.05 or more and a second active material having a ratio (Li/M) of 1.04 or less are used to obtain the positive electrode plate, a secondary battery that has excellent thermal stability and enhanced charged capacity tends to be obtained.

When the above-mentioned lithium-(transition metal) composite oxide in which the Ni content is 80 mol % or more of the total amount of the transition metal is used as the first active material and the second active material, it is possible to enhance the capacity of the secondary battery, but because the resistance of the positive electrode plate is decreased, the electric potential of the secondary battery tends to rise and the thermal stability tends to be degraded. Therefore, from the viewpoint of achieving excellent thermal stability and enhanced charged capacity, especially when using a first active material and a second active material that have a high Ni content in the transition metal, it is preferable to use a lithium-(transition metal) composite oxide that has the ratio (Li/M) falling within the above-mentioned range.

The crystallite size of the second active material may be 800 nm or more, or may be 850 nm or more, or may be 900 nm or more. The crystallite size of the second active material may be from 800 nm to 2000 nm, or from 800 nm to 1500 nm, or from 850 nm to 1200 nm, or from 900 nm to 1100 nm. When the second active material is a single particle, the crystallite size of the second active material is the size of the crystallite included in the single particle, and when the second active material is a secondary particle, the crystallite size is the size of the crystallite included in the primary particles that form the secondary particle. The crystallite size can be measured by X-ray diffraction. When the crystallite size of the second active material falls within the above-mentioned range, storage endurance of the secondary battery can be enhanced. In the positive electrode plate, even when a second active material having the above-mentioned crystallite size is used, a lithium-(transition metal) composite oxide having a ratio (Li/M) within the above-mentioned range is used as first particles and second particles. Therefore, with the use of this positive electrode plate, it is possible to obtain a secondary battery that has excellent thermal stability and enhanced charged capacity.

The average particle size (D50) (hereinafter also called “D50”) of the first active material is not particularly limited as long as it is greater than D50 of the second active material. D50 of the first active material is preferably from 12 μm to 20 μm, and it may be from 14 μm to 19 μm, or from 15 μm to 18 μm. When D50 of the first active material falls within the above-mentioned range, a secondary battery that has excellent thermal stability and enhanced charged capacity tends to be obtained. When the first active material is a secondary particle, D50 of the first active material is based on the particle size of the secondary particle. Herein, the average particle size (D50) refers to the particle size in volume-based particle size distribution at which cumulative frequency of particle sizes accumulated from the small size side reaches 50%. The volume-based particle size distribution can be measured with a laser-diffraction particle size distribution analyzer.

D50 of the second active material is not particularly limited as long as it is smaller than D50 of the first active material. D50 of the second active material is preferably from 2 μm to 8 μm, and it may be from 2 μm to 6 μm, or from 4 μm to 6 μm. When D50 of the second active material falls within the above-mentioned range, a secondary battery that has excellent thermal stability and enhanced charged capacity tends to be obtained. When the second active material is a single particle, D50 of the second active material is based on the particle size of the single particle, and when the second active material is a secondary particle, D50 of the second active material is based on the particle size of the secondary particle.

The first active material is preferably a secondary particle formed of primary particles aggregated together (aggregate particles), and the number of primary particles included in the secondary particle is 100 or more, for example. When each of the first active material and the second active material is a secondary particle, the number of primary particles included in a single first active material is preferably greater than the number of primary particles included in a single second active material.

The second active material is preferably at least one of a single particle and a secondary particle formed of up to three primary particles aggregated together, and, alternatively, it may be at least one of a single particle and a secondary particle formed of two primary particles aggregated together. The second active material may include a single particle and a secondary particle formed of up to three primary particles aggregated together. With this configuration, a secondary battery that has excellent thermal stability and enhanced charged capacity tends to be obtained. The particle size of the single particle or the primary particle constituting the second active material may be 0.7 μm or more, or 0.8 μm or more, or 1 μm or more, and, for example, it may be from 0.7 μm to 8 μm, or from 0.8 μm to 6 μm.

The mass ratio between the first active material and the second active material included in the positive electrode plate, ((first active material)/(second active material)), is preferably from 5/5 to 8/2, and may be from 5/5 to 7/3, or from 6/4 to 7/3. When the mass ratio ((first active material)/(second active material)) falls within the above-mentioned range, the packing properties of the first active material and the second active material in the positive electrode plate can be enhanced and the power output and the capacity of the secondary battery can be enhanced.

The positive electrode plate can have an active material layer that includes the first active material and the second active material, and the active material layer may be formed on a positive electrode current collector. The positive electrode current collector is a metal foil that is made by using an aluminum material such as aluminum and aluminum alloy, for example. The positive electrode plate may have a tab that is formed by using an aluminum material.

In addition to the first active material and the second active material, the active material layer may include other positive electrode active materials, and it may include a conductive material, a binder, and the like. The content of the first active material and the second active material relative to the total amount of the positive electrode active material included in the active material layer is preferably from 95 mass % to 100 mass %, more preferably from 95 mass % to 99 mass %, and it may be from 96 mass % to 98 mass %.

The conductive material may be a carbon material, for example. The carbon material may be one or more types selected from the group consisting of fibrous carbon, carbon black (such as acetylene black, Ketjenblack), coke, and activated carbon, for example. The fibrous carbon may be carbon nanotubes (CNTs), for example. The CNTs may be single-walled carbon nanotubes (SWCNTs), or may be multi-walled carbon nanotubes such as double-walled carbon nanotubes (DWCNTs).

The binder may be one or more types selected from the group consisting of styrene-butadiene rubber (SBR), polyvinylidene difluoride (PVdF), and polytetrafluoroethylene (PTFE), for example.

The positive electrode plate can be produced by, for example, forming an active material layer that includes the first active material and the second active material, on the positive electrode current collector. The active material layer can be formed by applying a slurry that includes the first active material and the second active material on the positive electrode current collector, and drying and compressing it. The slurry can further include a conductive material, a binder, and a solvent such as N-methyl-2-pyrrolidone (NMP).

### (Non-Aqueous Electrolyte Secondary Battery)

A secondary battery can include an electrode assembly that has the above-mentioned positive electrode plate, a negative electrode plate, and a separator interposed between the positive electrode plate and the negative electrode plate, as well as an electrolyte solution. The secondary battery may further include a battery case for accommodating the electrode assembly and the electrolyte solution.

The electrode assembly may be a stack-type electrode assembly that is made of a stack formed by stacking the positive electrode plate, the negative electrode plate, and the separator, or may be a wound-type electrode assembly that is formed by winding the stack. The plan-view shape of the stack-type electrode assembly may be tetragonal, preferably square or rectangular, more preferably rectangular. The wound-type electrode assembly may be a flat wound-type electrode assembly that is pressed after the stack is wound.

The negative electrode plate can have a negative electrode current collector and a negative electrode active material layer formed on the negative electrode current collector. The negative electrode current collector is a metal foil that is formed by using a copper material such as copper and copper alloy, for example. The negative electrode active material layer includes a negative electrode active material, and may further include either of or both a conductive material and a binder.

Examples of the negative electrode active material include carbon-based active materials that include a carbon (C) atom, such as graphite; and metal-based active materials that include a metallic element such as an elemental metal or a metal oxide including an element selected from the group consisting of silicon (Si), tin (Sn), antimony (Sb), bismuth (Bi), titanium (Ti), and germanium (Ge). Examples of the conductive material include carbon materials such as fibrous carbon, carbon black (such as acetylene black, Ketjenblack, for example), coke, activated carbon, and the like. Examples of the fibrous carbon include those described above. Examples of the binder include cellulose-based binding materials such as carboxymethylcellulose (CMC), styrene-butadiene rubber (SBR), and the like.

Examples of the separator include a porous sheet (such as a film, a nonwoven fabric) made of a resin such as polyethylene, polypropylene, polyester, cellulose, and polyamide. The porous sheet may have a monolayer structure, or may have a multilayer structure of two or more layers. The separator may have a functional layer on the surface of the porous sheet. The functional layer may be at least one of a heat-resistant layer, and an adhesive layer which is for adhesion to the positive electrode plate and the negative electrode plate.

The electrolyte solution may be a non-aqueous electrolyte solution, and, for example, it may be obtained by adding a supporting salt to a non-aqueous solvent such as an organic solvent. Examples of the non-aqueous solvent include ethylene carbonate (EC), propylene carbonate (PC), butylene carbonate (BC), dimethyl carbonate (DMC), ethyl methyl carbonate (EMC), diethyl carbonate (DEC), and the like. The electrolyte solution may include one, two, or more non-aqueous solvents among these. Examples of the supporting salt include lithium perchlorate (LiClO₄), lithium hexafluorophosphate (LiPF₆), lithium fluoroborate (LiBF₄), and the like. The electrolyte solution may include one, two, or more supporting salts among these. The electrolyte solution may further include an additive such as vinylene carbonate (VC), vinylethylene carbonate (VEC), fluoroethylene carbonate, and the like.

The battery case is preferably made of metal, and can be formed by using aluminum, aluminum alloy, iron, iron alloy, or the like, for example.

### EXAMPLES

In the following, the present disclosure will be described in further detail by way of Examples and Comparative Examples.

### [Analysis of Composition of First Active Material and Second Active Material]

The composition of the first active material and the second active material was analyzed by high-frequency inductively coupled plasma (ICP) emission spectrometry.

### [Measurement of Average Particle Size (D50) of First Active Material and Second Active Material]

The average particle size (D50) of the first active material and the second active material was measured with a laser-diffraction particle size distribution analyzer

(“Mastersizer-3000” manufactured by Malvern Panalytical).

### [Measurement of Crystallite Size]

The crystallite size of the second active material was calculated by using an X-ray diffraction apparatus (“SmartLab” manufactured by Rigaku), from the peak intensity of a (104) plane.

### Production Example 1

### (Production of First Active Material)

A transition metal compound represented by Ni_{0.80}Co_{0.05}Mn_{0.15}(OH)₂ and LiOH were mixed together and calcined, and thereby a first active material was obtained, which was a lithium-(transition metal) composite oxide having a ratio (Li/M) between the number of moles of Li and the total number of moles of transition metal (M) of 1.05 and having an average particle size (D50) of 17.2 μm.

An NiCoMn composite hydroxide and a lithium compound were mixed together and calcined at a temperature from 700 to 1000° C. to obtain first active materials, namely lithium-(transition metal) composite oxides having a ratio (Li/M) between the number of moles of Li and the total number of moles of transition metal (M) of 1.03, 1.07, 1.09, and 1.12, respectively. The average particle size of these first active materials fell within the range of 12 μm to 20 μm.

(Production of Positive Electrode Plate (r1))

Each of the first active materials obtained in the above-mentioned manner having the above-mentioned ratio (Li/M) was used to produce a positive electrode plate (r1) according to the procedure described below. Firstly, 97.5 parts by mass of the first active material, 1.5 parts by mass of carbon black as a conductive material, and 1.0 part by mass of polyvinylidene difluoride (PVdF) as a binder were mixed together, followed by further adding a proper amount of N-methyl-2-pyrrolidone (NMP), and thereby a slurry was obtained. The resulting slurry was applied to an aluminum foil that served as a positive electrode current collector, dried, and rolled with a roller to a certain thickness. In this way, a positive electrode active material layer having a density of 3.30 g/cm³ was formed on the aluminum foil, and thereby a positive electrode plate raw sheet (r1) was obtained. The resulting positive electrode plate raw sheet (r1) was cut into a certain size, and thereto, an aluminum tab was attached, and thereby a positive electrode plate (r1) was obtained.

### (Preparation of Electrolyte Solution)

To a mixed solvent obtained by mixing non-aqueous solvents, namely, ethylene carbonate (EC) and ethyl methyl carbonate (EMC) in a volume ratio of EC:EMC=30:70, lithium hexafluorophosphate (LiPF₆) was added as a supporting salt in an amount to achieve a concentration of 1 mol/L per 1 L of the mixed solvent, and also vinylene carbonate (VC) was added in an amount to achieve a content of 0.3 mass % relative to the total mass of the mixed solvent, to prepare an electrolyte solution.

(Production of Test Cell (r1))

Each of the positive electrode plates (r1) obtained in the above-described manner was used to produce a test cell (r1) according to the procedure described below. The positive electrode plate (r1) and a lithium metal plate, which served as a counter electrode to the positive electrode plate (r1), were stacked with a polyolefin separator interposed therebetween, and thereby a stack-type electrode assembly was obtained. The resulting stack-type electrode assembly was placed in a battery case made of an aluminum laminated sheet, and the electrolyte solution prepared in the above-described manner was injected thereinto, followed by sealing the opening, and thereby a test cell (r1) was obtained.

Each test cell (r1) was subjected to constant-current charging under conditions at a temperature of 25° C. and at a current density of 0.2 mA/cm² until the electric potential reached 4.3 V vs. Li/Lit, and then further subjected to constant-voltage charging at an electric potential of 4.3 V vs. Li/Li⁺ until the current density reached 0.04 mA/cm², followed by measurement of the charged capacity per unit mass of the first active material [mAh/g]. In addition, the ratio of capacity at an electric potential of 4.1 V vs. Li/Li⁺ or more relative to the total capacity of the test cell (r1) at the time of charging the test cell (r1) was calculated. Results are shown in FIG. 1 and Table 1.

FIG. 1 is a plot of the results shown in Table 1, and is a graph of charged capacity [mAh/g] and the ratio [%] of capacity at an electric potential of 4.1 V vs. Li/Li⁺ or more at the time of charging the test cell (r1) having the positive electrode plate (r1) formed by using the first active material, plotted with respect to the ratio (Li/M) between the number of moles of lithium (Li) and the total number of moles of transition metal (M) in the first active material. From the graph in FIG. 1 and from Table 1, it is indicated that when the ratio (Li/M) in the first active material is less than 1.05, relative to the total capacity at the time of charging the test cell (r1), the ratio of capacity at an electric potential of 4.1 V vs. Li/Li⁺ or more is great.

TABLE 1

| | Test cell (r1) | |
|---|---|---|
| | | Ratio of capacity at |
| Positive electrode plate (r1) | Charged | electric potential of |
| First active material | capacity | 4.1 V vs. Li/Li⁺ or more |
| Ratio (Li/M) | [mAh/g] | [%] |
| 1.03 | 227.93 | 22.7 |
| 1.05 | 227.01 | 21.2 |
| 1.07 | 226.10 | 21.1 |
| 1.09 | 224.07 | 21.0 |
| 1.12 | 221.35 | 20.9 |

### Production Example 2

### (Production of Second Active Material)

A transition metal compound represented by Ni_{0.83}Co_{0.12}Mn_{0.05}(OH)₂ and LiOH were mixed together and calcined, and thereby a second active material was obtained, which was a lithium-(transition metal) composite oxide having a ratio (Li/M) between the number of moles of Li and the total number of moles of transition metal (M) of 1.01. The average particle size (D50) of the second active material was 5.9 μm, and the crystallite size thereof was 965 nm.

An NiCoMn composite hydroxide and a lithium compound were mixed together and calcined at a temperature from 700 to 1000° C. to obtain second active materials, namely lithium-(transition metal) composite oxides having a ratio (Li/M) between the number of moles of Li and the total number of moles of transition metal (M) of 0.98, 1.00, 1.04, 1.07, and 1.10, respectively. The average particle size of these second active materials fell within the range of 2 μm to 8 μm, and the crystallite size thereof fell within the range of 800 nm or more.

(Production of Positive Electrode Plate (r2))

By the procedure described in “Production of Positive Electrode Plate (r1)” except that the second active material was used instead of the first active material, a positive electrode plate (r2) was obtained.

(Production of Test Cell (r2))

By the procedure described in “Production of Test Cell (r1)” except that the positive electrode plate (r2) was used instead of the positive electrode plate (r1), a test cell (r2) was obtained.

By the same procedure as used for the test cell (r1), the test cell (r2) was also subjected to constant-current charging and constant-voltage charging, and the charged capacity per unit mass of the second active material [mAh/g] was measured. In addition, the ratio of capacity at an electric potential of 4.1 V vs. Li/Li⁺ or more relative to the total capacity of the test cell (r2) at the time of charging the test cell (r2) was calculated. Results are shown in FIG. 2 and Table 2.

FIG. 2 is a plot of the results shown in Table 2, and is a graph of charged capacity [mAh/g] and the ratio [%] of capacity at an electric potential of 4.1 V vs. Li/Li⁺ or more at the time of charging the test cell (r2) having the positive electrode plate (r2) formed by using the second active material, plotted with respect to the ratio (Li/M) between the number of moles of lithium (Li) and the total number of moles of transition metal (M) in the second active material. From the graph in FIG. 2 and from Table 2, it is indicated that when the ratio (Li/M) in the first active material is more than 1.04, the charged capacity at the time of charging the test cell (r2) is degraded by a great margin.

TABLE 2

| | Test cell (r2) | |
|---|---|---|
| | | Ratio of capacity at |
| Positive electrode plate (r2) | Charged | electric potential of |
| Second active material | capacity | 4.1 V vs. Li/Li⁺ or more |
| Ratio (Li/M) | [mAh/g] | [%] |
| 0.98 | 229.0 | 19.6 |
| 1.00 | 228.9 | 19.0 |
| 1.01 | 228.9 | 18.9 |
| 1.04 | 228.1 | 18.3 |
| 1.07 | 221.8 | 18.2 |
| 1.10 | 221.7 | 17.5 |

### Examples 1 to 3, Comparative Examples 1 to 3

### (Production of Positive Electrode Plate)

The first active material and the second active material each having the ratio (Li/M) as specified in Table 3 were mixed in a mass ratio of (first active material):(second active material)=6:4, and thereby a positive electrode active material was prepared. By the procedure described in “Production of Positive Electrode Plate (r1)” except that the positive electrode active material was used instead of the first active material, a positive electrode plate was obtained.

### (Production of Non-Aqueous Electrolyte Secondary Battery)

By the procedure described in “Production of Test Cell (r1)” except that the positive electrode plate obtained in the above-described manner was used instead of the positive electrode plate (r1), a non-aqueous electrolyte secondary battery was obtained.

The non-aqueous electrolyte secondary battery was subjected to constant-current charging and constant-voltage charging following the same procedure as that for the test cell (r1), and the charged capacity per unit mass of the positive electrode active material [mAh/g] was measured. In addition, the ratio of capacity at an electric potential of 4.1 V vs. Li/Li⁺ or more at the time of charging the non-aqueous electrolyte secondary battery was calculated. Results are shown in Table 3.

TABLE 3

| | Positive electrode active | | | |
|---|---|---|---|---|
| | material | | | |
| | First | Second | Secondary battery | |
| | active | active | | Ratio of capacity at |
| | material | material | Charged | electric potential of |
| | Ratio | Ratio | capacity | 4.1 V vs. Li/Li⁺ or more |
| | (Li/M) | (Li/M) | [mAh/g] | [%] |
| Comp. | 1.03 | 1.01 | 228.4 | 21.4 |
| Ex. 1 | | | | |
| Ex. 1 | 1.05 | 1.01 | 228.0 | 20.4 |
| Ex. 2 | 1.07 | 1.01 | 227.3 | 20.2 |
| Ex. 3 | 1.09 | 1.04 | 226.1 | 20.2 |
| Comp. | 1.07 | 1.07 | 224.3 | 19.7 |
| Ex. 2 | | | | |
| Comp. | 1.03 | 1.07 | 225.3 | 21.1 |
| Ex. 3 | | | | |

Referring to Table 3, it is indicated that the positive electrode plate formed by using the positive electrode active material that includes the first active material having a ratio (Li/M) of 1.05 or more and the second active material having a ratio (Li/M) of 1.04 or less allows for obtaining a non-aqueous electrolyte secondary battery that has enhanced charged capacity and excellent thermal stability.

### [Evaluation of Packing Properties]

The first active material having a ratio (Li/M) of 1.05 and the second active material having a ratio (Li/M) of 1.01 were mixed in a mass ratio specified in Table 4, and the density thereof while pressed by a pressure of 200 Pa was measured. Results are shown in Table 4.

TABLE 4

| Mixing ratio of positive | |
|---|---|
| electrode active material | |
| (first active material)/ | |
| (second active material) | Density after pressing [g/cm³] |
| 100/0 | 3.26 |
| 90/10 | 3.36 |
| 80/20 | 3.46 |
| 70/30 | 3.55 |
| 60/40 | 3.59 |
| 50/50 | 3.59 |

Referring to Table 4, it is indicated that when the mass ratio (first particles)/(second particles) falls within the range of 5/5 to 8/2, the density can be 3.40 g/cm³ or more and good packing properties are obtained.

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode plate comprising:
a first active material that is a lithium-(transition metal) composite oxide; and
a second active material that is a lithium-(transition metal) composite oxide having a smaller average particle size (D50) than the first active material, wherein
a crystallite size of the second active material is 800 nm or more,
a ratio (Li/M) between a number of moles of lithium (Li) and a total number of moles of transition metal (M) in the first active material is 1.05 or more, and
a ratio (Li/M) between a number of moles of lithium (Li) and a total number of moles of transition metal (M) in the second active material is 1.04 or less.

2. The positive electrode plate according to claim 1, wherein the ratio (Li/M) between a number of moles of lithium (Li) and a total number of moles of transition metal (M) in the first active material is 1.12 or less.

3. The positive electrode plate according to claim 1, wherein the ratio (Li/M) between a number of moles of lithium (Li) and a total number of moles of transition metal (M) in the second active material is 0.98 or more.

4. The positive electrode plate according to claim 1, wherein the ratio (Li/M) between a number of moles of lithium (Li) and a total number of moles of transition metal (M) in the second active material is 1.01 or more.

5. The positive electrode plate according to claim 1, wherein a mass ratio between the first active material and the second active material ((first active material)/(second active material)) is from 5/5 to 8/2.

6. The positive electrode plate according to claim 1, wherein an average particle size (D50) of the first active material is from 12 μm to 20 μm.

7. The positive electrode plate according to claim 1, wherein an average particle size (D50) of the second active material is from 2 μm to 8 μm.

8. The positive electrode plate according to claim 1, wherein each of the first active material and the second active material includes nickel (Ni) in an amount of 80 mol % or more of a total amount of transition metal.

9. The positive electrode plate according to claim 1, wherein the second active material is at least one of a single particle and a secondary particle formed of up to three primary particles aggregated together.

10. A non-aqueous electrolyte secondary battery comprising:
an electrode assembly having the positive electrode plate according to claim 1, a negative electrode plate, and a separator interposed between the positive electrode plate and the negative electrode plate; and
an electrolyte solution.
